(19) United States
(12) Patent Application Publication
(10) Pub. No.: US 2006/0065309 A1
(43) Pub. Date: Mar. 30, 2006

(54) Air compressor assembly having removable air compressor

(76) Inventors: Jeremy D. Leasure, Jackson, TN (US); Timothy C. Smith, Jackson, TN (US); John W. Hardin, Medina, TN (US); Mark W. Wood, Jackson, TN (US)

Correspondence Address: SUITER WEST SWANTZ PC LLO, 14301 FNB PARKWAY, SUITE 220, OMAHA, NE, 68154, US

(21) Appl. No.: 11/238,101

(22) Filed: Sep. 28, 2005

Related U.S. Application Data
(60) Provisional application No. 60/613,746, filed on Sep. 28, 2004.

(51) Int. Cl. B67D 5/00

(52) U.S. Cl. 137/565.18

(57) ABSTRACT

An air compressor assembly includes an air compressor mounted to a compressed air storage tank via a mounting assembly. The mounting assembly allows removal of the air compressor from the compressed air storage tank so that the air compressor and the compressed air storage tank may be utilized independently of the other.

### CROSS-REFERENCE TO RELATED APPLICATIONS

The present application claims the benefit under 35 U.S.C. § 119(e) of U.S. Provisional Application Serial No. 60/613,746, filed Sep. 28, 2004, which is herein incorporated by reference in its entirety.

### FIELD OF THE INVENTION

The present invention generally relates to the field of air compressors, and more particularly to an air compressor assembly having an air compressor and a compressed air storage tank, wherein the air compressor is removable from the compressed air storage tank so that either may be utilized separately from the other.

### BACKGROUND OF THE INVENTION

Air compressor assemblies typically include an air compressor, having a motor driven pump, mounted to a compressed air storage tank. This configuration allows for the operation of an air powered tool from the reservoir of compressed air stored in the compressed air storage tank. When the supply of pressurized air in the compressed air storage tank becomes depleted by the operation of the air powered tool, the air compressor may be operated for repressurizing the compressed air storage tank. In this manner, air compressor assemblies are used to provide compressed air for operating air powered tools such as nailing tools, socket driving tools, material shaping tools, sanding tools, spray painting tools, inflation chucks, and the like.

However, in some applications it may be desirable to operate the air compressor portion of the air compressor assembly without utilizing the compressed air storage tank portion, such as when inflating an automobile tire. In other applications it may be desirable to utilize the compressed air storage tank portion of the air compressor assembly without operating the air compressor portion, such as when intermittent repressurization of the compressed air storage tank is not required. Further, it may be desirable to transport either portion of the air compressor assembly separately from the other. For example, it may be desirable to carry the air compressor portion to a remote location where it would be difficult to wheel the entire air compressor assembly.

Thus, it would be desirable to provide an air compressor assembly having an air compressor and a compressed air storage tank which may be utilized independently from one another.

### SUMMARY OF THE INVENTION

Accordingly, the present invention is directed to an air compressor assembly having an air compressor and a compressed air storage tank, wherein the air compressor is removable from the compressed air storage tank, and either may be utilized separately from the other. In exemplary embodiments, the air compressor assembly includes a mounting assembly for mounting the air compressor to the compressed air storage tank so that the air compressor is removable from the compressed air storage tank.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric view illustrating an air compressor assembly in accordance with an exemplary embodiment of the present invention including an air compressor and a compressed air storage tank, wherein the air compressor is removable from the compressed air storage tank and either may be utilized separately from the other;

FIG. 2 is a front view of the air compressor assembly illustrated in FIG. 1;

FIG. 3 is a side view of the air compressor assembly illustrated in FIG. 1;

FIG. 4 is an isometric view of the air compressor assembly illustrated in FIG. 1, wherein the air compressor is removed from the compressed air storage tank;

FIG. 5 is a partial isometric view of the air compressor assembly illustrated in FIG. 1, further illustrating a mounting collar and a mounting clip for docking the air compressor with the compressed air storage tank;

FIG. 6 is an isometric view illustrating an air compressor assembly in accordance with another exemplary embodiment of the present invention including an air compressor, a compressed air storage tank, and a storage case, wherein the air compressor is removable from the compressed air storage tank and either may be utilized separately from the other; and

FIG. 7 is a block diagram illustrating an air compressor assembly in accordance with an exemplary embodiment of the present invention including an air compressor and a compressed air storage tank, wherein the air compressor is removable from the compressed air storage tank and either may be utilized separately from the other.

### DETAILED DESCRIPTION OF THE INVENTION

Reference will now be made in detail to the presently preferred embodiments of the invention, examples of which are illustrated in the accompanying drawings.

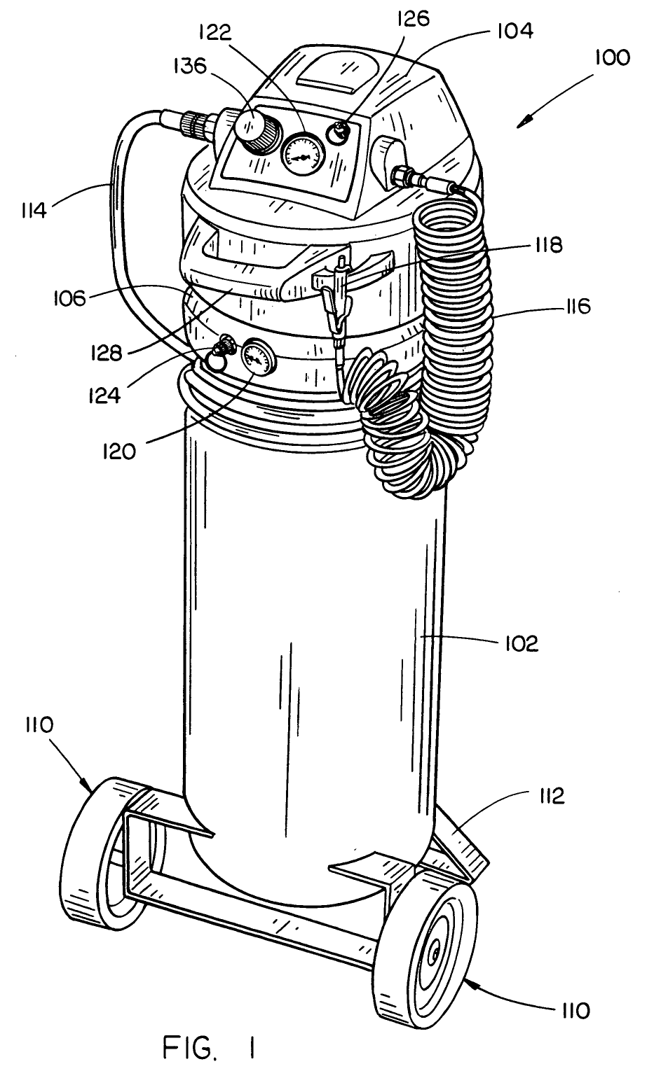

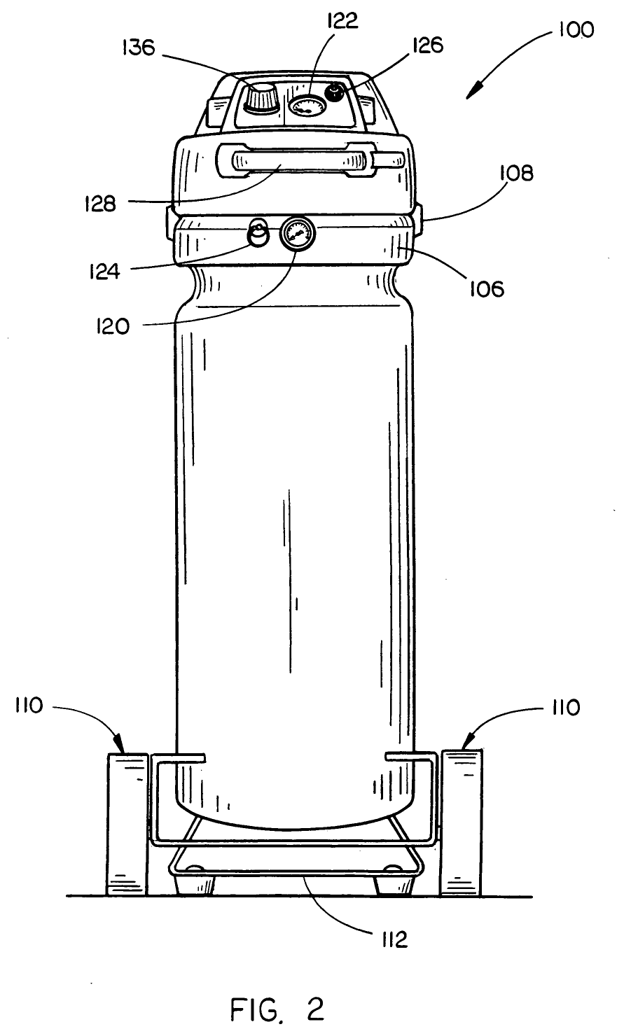

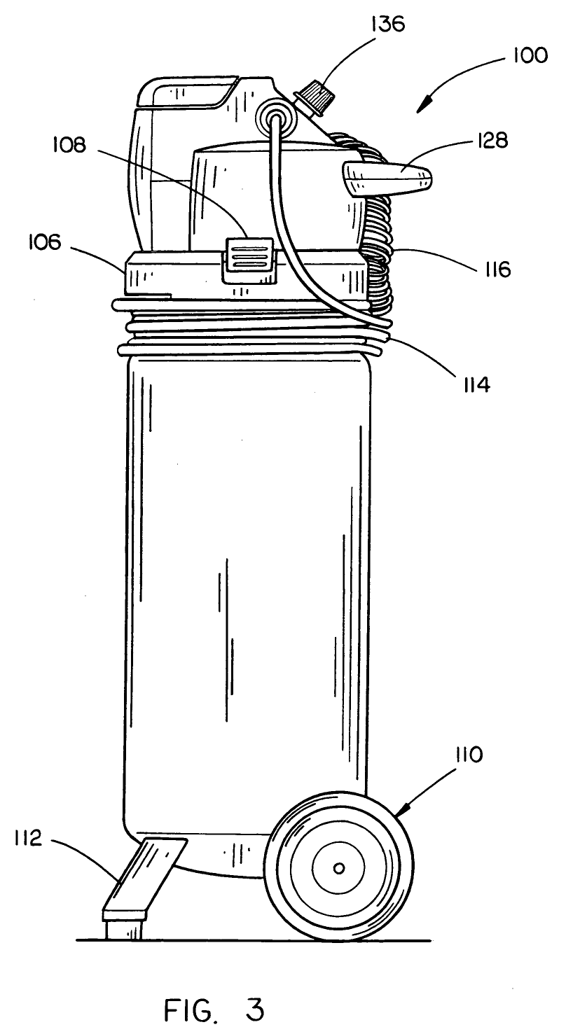

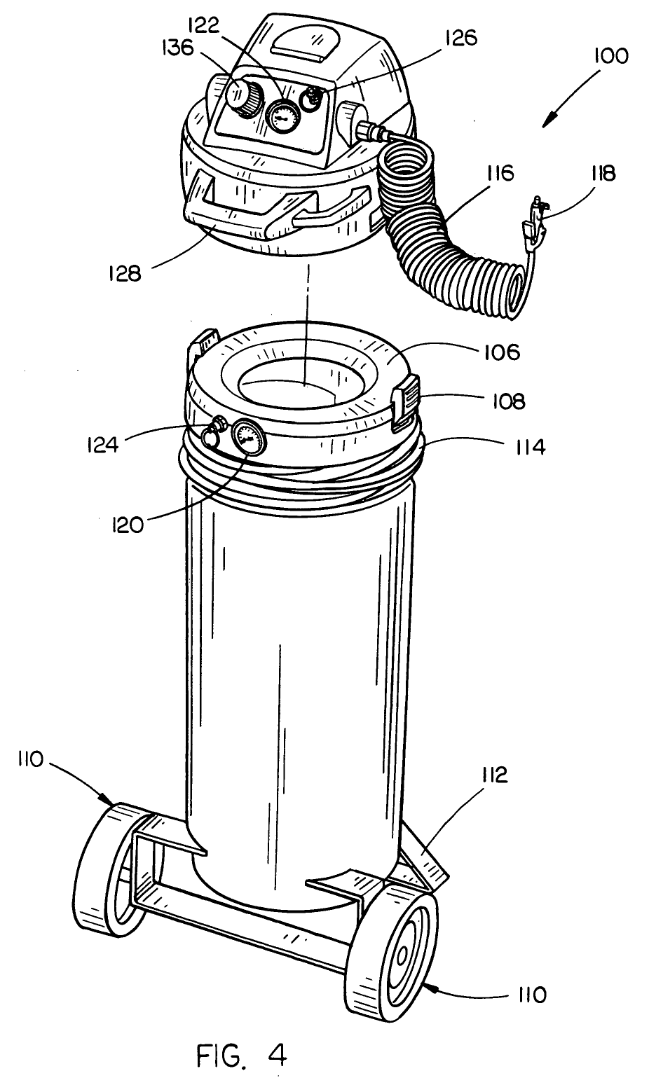

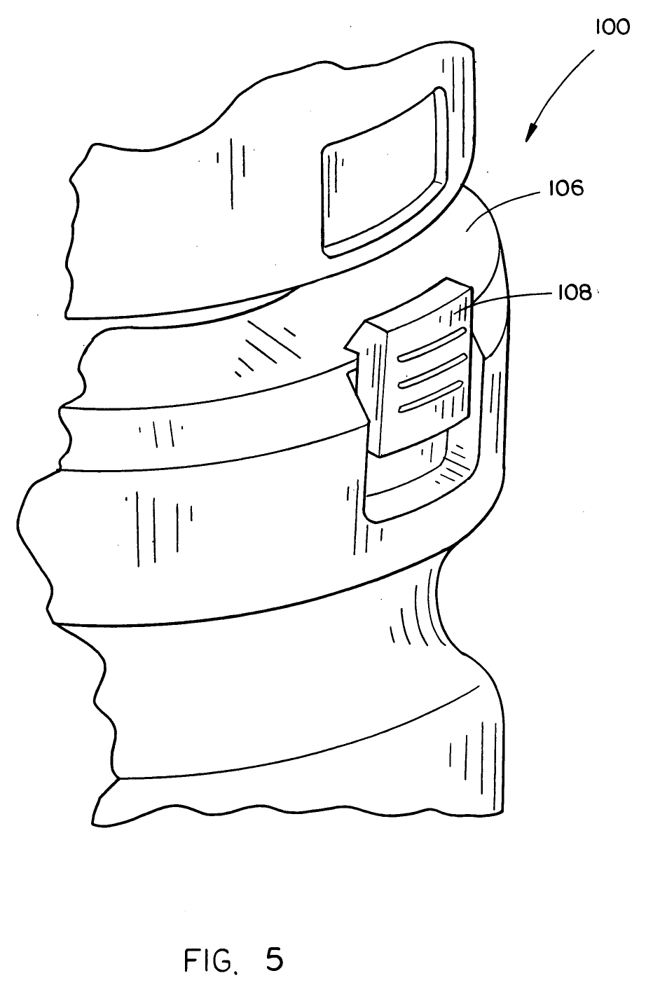

Referring now to FIGS. 1 through 7, an air compressor assembly 100 is described in accordance with exemplary embodiments of the present invention. The air compressor assembly 100 includes a compressed air storage tank 102 and an air compressor 104 which is mounted to the compressed air storage tank 102. As shown in FIG. 4, the air compressor 104 is removable from the compressed air storage tank 102 so that either may be utilized separately from the other. Thus, the air compressor 104 may be removed from the compressed air storage tank 102 and used separately (e.g., as an inflator, or the like) for supplying compressed air, inflation chucks, and the like. Similarly, the compressed air storage tank 102 may be used, without the air compressor 104, to supply compressed air for such applications until the supply of compressed air contained therein is exhausted. The air compressor 104 may further be coupled to the compressed air storage tank 102 and used to recharge the tank with compressed air for supplying compressed air to air powered tools, such as pneumatic fasteners or nailers, impact wrenches, ratchet wrenches, sprayers, grinders, sanders, and the like. In exemplary embodiments, the air compressor 104 may further include a pressure regulator assembly for regulating the pressure of compressed air in the compressed air storage tank 102.

A mounting assembly, such as the mounting collar 106 shown in FIGS. 1 through 5, is utilized for docking the air compressor 104 with the compressed air storage tank 102. As shown, the mounting collar 106, which is affixed to the compressed air storage tank 102, comprises a latch assembly 108 including latches or clamps which secure the air compressor 104 to the compressed air storage tank 102. In embodiments, the housing of the air compressor 104 may include one or more slots which are engaged by a corresponding tab of the latches of the latch assembly 108. Alternatively, the latches of the latch assembly 108 may be mounted to the housing of the air compressor 104 to engage slots formed in the mounting collar 106. In the embodiment illustrated, the latches of the latch assembly 108 are spring loaded and biased into a position for engaging the slots for securing the air compressor 104 to the compressed air storage tank 102.

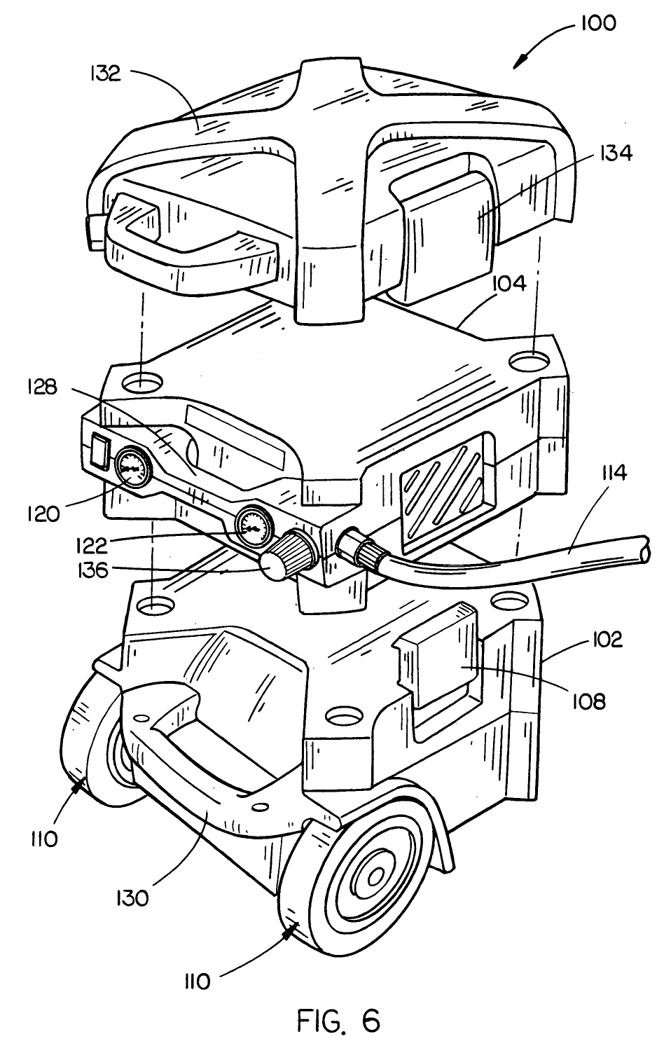

It is contemplated that in embodiments of the invention, the mounting collar 106 may be eliminated. In such embodiments, a latching mechanism may be mounted directly to the compressed air storage tank 102 or the air compressor 104 for securing the air compressor 104 to the compressed air storage tank. For example, the latch assembly 108 illustrated in FIG. 6 is mounted directly to the compressed air storage tank 102 for connecting the compressed air storage tank 102 to the air compressor 104. It is further contemplated that the air compressor 104 may be secured to the compressed air storage tank 102 in a variety of other ways without departing from the scope and intent of the present invention. For example, the air compressor 104 may be secured to the compressed air storage tank 102 via one or more fasteners, or via other specialized mounting assemblies.

In FIGS. 1 through 5, the air compressor assembly 100 is illustrated having a vertically oriented compressed air storage tank 102. However, it will be appreciated that other orientations may be utilized for the compressed air storage tank 102 of the present invention, including compressed air storage tanks having a horizontal orientation, compressed air storage tanks configured as a “pancake” style air storage tank, and compressed air storage tanks having specialized shapes such as the compressed air storage tank 102 illustrated in FIG. 6. Further, it should be noted that the air compressor assembly 100 may include more than one compressed air storage tank, such as two air storage tanks mounted side-by-side, or the like. The use of compressed air storage tanks 102 having configurations other than those specifically illustrated herein is well known in the art. Consequently, the substitution of such tanks in place of the compressed air storage tanks 102 specifically illustrated in FIGS. 1 through 6 does not depart from the scope and intent of the present invention.

The air compressor assembly 100 further includes a first pressure hose 114 coupled to the compressed air storage tank 102. As shown, the first pressure hose 114 is utilized for connecting the compressed air storage tank 102 to the air compressor 104 for repressurizing the air storage tank as necessary. However, it will be appreciated that the first pressure hose 114 may be replaced by a direct connection between the compressed air storage tank 102 and the air compressor 104, such as a fitting engaged by the air compressor 104 when it is attached to the compressed air storage tank 102, or the like. Additionally, the first pressure hose 114 may be utilized in combination with such a fitting. Preferably, the mounting collar 106 and the compressed air storage tank 102 are shaped to provide a circumferential channel for allowing the first pressure hose 114 to be wrapped around the compressed air storage tank 102 for storage. The first pressure hose 114 may be provided with fittings for engaging the compressed air storage tank 102 and the air compressor 104. For example, in one specific embodiment, spring loaded coupling mechanisms (i.e., “quick-connect” couplings) may be utilized for connecting the first pressure hose 114 to the compressed air storage tank 102 and/or the air compressor 104, while in another specific embodiment, a threaded coupling mechanism is utilized.

As shown, a second pressure hose 116 may be coupled to the air compressor 104. The second pressure hose 116 may be fitted with a variety of fittings for supplying compressed air from the air compressor 104. For example, in the embodiment shown, the second pressure hose 116 is fitted with a pressure fitting 118 having a handle and a thumb switch, or the like, for being selectively operated by a user of the air compressor assembly 100. Those of skill in the art will appreciate that various other fittings 118 commonly in use and well known to the art may be utilized with the air compressor 104 without departing from the scope and intent of the present invention.

As shown, the air compressor 104 further includes a pressure regulator 136 having a dial or like control for selecting the supply pressure of air delivered by the air compressor assembly 100. Those of skill in the art will appreciate that other dials and controls may be provided for regulating the supply pressure of air delivered by the air compressor assembly 100 and/or the pressure of the compressed air in the compressed air storage tank 102 without departing from the scope and intent of the present invention.

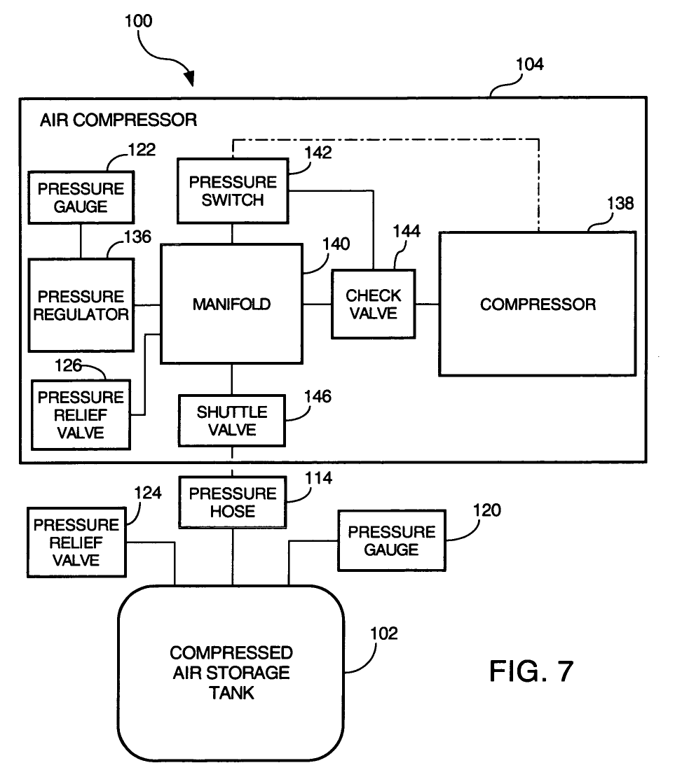

In exemplary embodiments, the first pressure hose 114 is utilized for alternately charging the compressed air storage tank 102 with compressed air and supplying compressed air from the compressed air storage tank 102. For example, as seen in a specific embodiment illustrated in FIG. 7, the air compressor 104 includes a compressor 138 comprising a motor driven pump, or like apparatus, for pressurizing the compressed air storage tank 102. The compressor 138 is connected to a manifold is 140 and a pressure switch 142. Preferably, the compressor 138 is connected to the manifold 140 and the pressure switch 142 via a one-way valve, such as a check valve 144, or the like.

The pressure switch 142 operates the compressor 138 for supplying pressurized air to the compressed air storage tank 102. For example, the pressure switch 142 operates the compressor 138 to charge the compressed air storage tank 102 to a pre-determined pressurization level. When the compressed air storage tank has been adequately pressurized (i.e., when the pre-determined pressurization level has been reached), the pressure switch 142 operates to stop the compressor 138 from supplying pressurized air to the compressed air storage tank. In one specific embodiment, the pressure switch 142 is electrically coupled with an electrically powered compressor 138 for electrically actuating the compressor 138, causing it to operate until the compressed air storage tank 102 has been adequately pressurized.

The manifold 140 comprises an air tank appropriately sized for containment within the air compressor 104, while providing enough volume to keep the pressure switch 142 operating to supply pressurized air from the air compressor 104 (e.g., when the air compressor 104 is disconnected from the compressed air storage tank 102). The manifold 140 is coupled with the pressure relief valve 126, and the pressure regulator 136. The pressure regulator is connected to the pressure gauge 122 and possibly the second pressure hose 116 for supplying pressurized air to air powered tools, such as pneumatic fasteners or nailers, impact wrenches, ratchet wrenches, sprayers, grinders, sanders, and the like.

The manifold is coupled with the compressed air storage tank 102 via a shuttle valve 146 when the air compressor 104 is connected to the compressed air storage tank 102 via the pressure hose 114. In exemplary embodiments, the shuttle valve 146 comprises a coupling mechanism which is sealed when the pressure hose 114 is disconnected from the air compressor 104, and opened when the pressure hose 114 is connected to the air compressor 104. For example, the shuttle valve 146 may include a male-ended spring loaded coupling mechanism (i.e., a “quick-connect” coupling) for connected to a female ended quick-connect coupling on the pressure hose 114. When the male and female ends of the quick-connect couplings are separated, the shuttle valve 146 is biased closed, while connecting the shuttle valve 146 with the pressure hose 114 biases the shuttle valve 146 open.

The second pressure hose 116 may be utilized for supplying pressurized air from the compressor 138 when the air compressor 104 is disconnected from the compressed air storage tank 102. Alternatively, the second pressure hose 116 may be utilized for supplying pressurized air from the compressed air storage tank 102 when the air compressor 104 is connected to the compressed air storage tank 102. Moreover, the first pressure hose 114 may be utilized for supplying air to the second pressure hose 116, when connected to the air compressor 104, or alternatively, supplying air directly from the compressed air storage tank 102, when the compressed air storage tank 102 is disconnected from the air compressor 104. In this manner the air compressor 104 is removable from the compressed air storage tank 102 so that either may be utilized separately from the other.

In other exemplary embodiments, the compressed air storage tank 102 may include a port for connecting a third pressure hose (not shown). The third pressure hose may be fitted with a variety of fittings for supplying compressed air from the compressed air storage tank 102. For example, the third pressure hose may be fitted with a pressure fitting for connecting air powered tools, such as pneumatic fasteners or nailers, impact wrenches, ratchet wrenches, sprayers, grinders, sanders, and the like. Those of skill in the art will appreciate that various fittings commonly in use and well known to the art may be utilized with the compressed air storage tank 102 and the third pressure hose without departing from the scope and intent of the present invention. Further, it will be appreciated that additional components may be utilized for coupling the third pressure hose with the compressed air storage tank 102, including a safety valve, a pressure regulator for regulating the supply of compressed air from the third pressure hose, a pressure gauge for indicating the pressure of compressed air in the third pressure hose, and other various equipment.

In exemplary embodiments, both the compressed air storage tank 102 and the air compressor 104 may include a pressure gauge. For example, in the specific embodiment illustrated in FIGS. 1 through 5, the compressed air storage tank 102 includes a first pressure gauge 120 for indicating the pressure of the compressed air in the compressed air storage tank 102. In this embodiment, the air compressor 104 includes a second pressure gauge 122 for indicating the supply pressure of air delivered by the air compressor 104. Alternatively, either of the compressed air storage tank 102 and the air compressor 104 may include one or both of the first and second pressure gauges 120 and 122. For example, in the specific embodiment illustrated in FIG. 6, two pressure gauges may be included with the air compressor 104. In this embodiment, a first pressure gauge 120 indicates the pressure of the compressed air in the compressed air storage tank 102 while the second pressure gauge 122 indicates the supply pressure of air delivered by the air compressor 104. Those of skill in the art will appreciate that the air compressor assembly 100 may include other gauges as necessary for operation of the air compressor assembly 100 without departing from the scope and intent of the present invention. For instance, in one specific embodiment, the second pressure gauge 122, or alternatively, a third pressure gauge, may be used for indicating a user-defined limit for the pressurization of the compressed air storage tank 102.

Both the compressed air storage tank 102 and the air compressor 104 may further include a pressure relief valve for venting or relieving pressure in the air compressor assembly 100. For example, in the embodiment shown in FIGS. 1 through 5, the compressed air storage tank 102 includes a first pressure relief valve 124 for venting pressure from the compressed air storage tank 102, while the air compressor 104 includes a second pressure relief valve 126 for venting pressurized air trapped in the air compressor 104 (e.g., within the air compressor's manifold) and/or venting pressure in the compressed air storage tank 102. Alternatively, only one of the compressed air storage tank 102 and the air compressor 104 may be provided with a pressure relief valve.

In the embodiment illustrated, the compressed air storage tank 102 includes a wheel assembly 110 and a base 112 for transporting and supporting the air compressor assembly 100. The compressed air storage tank 102 may further include a handle 130 for use while the air compressor 104 is removed from the compressed air storage tank 102 during transport of the compressed air storage tank 102 via the wheel assembly 110.

In exemplary embodiments, the air compressor 104 includes a handle assembly 128, for utilization while transporting either of the air compressor 104 alone or the air compressor assembly 100. For example, the handle assembly 128 may be utilized for transporting the air compressor 104 when it has been removed from the compressed air storage tank 102. Alternatively, the handle assembly 128 may be utilized for transporting the air compressor assembly 100 when the air compressor 104 is docked with the compressed air storage tank 102. The handle assembly 128 may include an attachment point for the pressure fitting 118. In exemplary embodiments, the handle of the pressure fitting 118 may connect with the handle assembly 128 for stowing the pressure fitting when not in use and/or connecting the second pressure hose 116 to the air compressor assembly 100.

In exemplary embodiments, the air compressor assembly 100 may further include a storage case 132 for collecting accessories such as air powered tools, inflation chucks, air hose, miscellaneous items, and equipment. For example, the storage case 132 may be connected to the air compressor 104 via a second latch assembly 134, or the like. In embodiments, the air compressor 104 may include a slot engaged by a corresponding tab on the latches of the second latch assembly 134. Alternatively, the latches of the second latch assembly 134 may be mounted to the air compressor 104 for engaging a slot formed in the storage case 132. Like the first latch assembly 108, the latches of the second latch assembly 134 may be spring loaded and biased into a position for securing the storage case 132 to the air compressor 104. Again, those of skill in the art will appreciate that the storage case 132 may attach to the air compressor 104 in a variety other ways without departing from the scope and intent of the present invention. For example, the storage case 132 may be secured to the air compressor 104 via one or more fasteners, or via other specialized mounting assemblies. Further, it is contemplated that the storage case 132, the air compressor 104, and the compressed air storage tank 102 may be coupled with one another in a variety of ways without departing from the scope and intent of the present invention. Alternatively, instead of the storage case 132 shown in FIG. 6, a storage compartment having a hinged or detachable lid may be provided in the housing of the air compressor 104 so that the storage compartment 132 is integral to the air compressor 104.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof.

What is claimed is:

1. An air compressor assembly, comprising:
a compressed air storage tank for storing compressed air; and
an air compressor mounted to the compressed air storage tank for providing compressed air suitable for storage in the compressed air storage tank, the air compressor being removable from the compressed air storage tank;
wherein at least one of the air compressor and the compressed air storage tank is configured for being used independently of the other of the air compressor and the compressed air storage tank for providing compressed air.

2. The air compressor assembly as claimed in claim 1, further comprising a mounting assembly for mounting the air compressor to the compressed air storage tank so that the air compressor is removable from the compressed air storage tank.

3. The air compressor assembly as claimed in claim 2, wherein the compressed air storage tank comprises a vertically oriented cylindrical compressed air storage tank having an upper end and a lower end and the mounting assembly comprises a mounting collar disposed over the upper end for receiving the air compressor.

4. The air compressor assembly as claimed in claim 3, wherein the mounting collar includes a pressure gage and a pressure relief valve.

5. The air compressor assembly as claimed in claim 2, wherein the mounting assembly comprises a latch assembly for engaging the air compressor for securing the air compressor to the compressed air storage tank.

6. The air compressor assembly as claimed in claim 1, further comprising a hose assembly for coupling the air compressor to the compressed air storage tank for supplying compressed air to the air storage tank.

7. The air compressor assembly as claimed in claim 1, wherein the hose assembly is used to draw air from the compressed air storage tank when the air compressor is detached from the compressed air storage tank.

8. The air compressor assembly as claimed in claim 1, wherein the air compressor supplies compressed air to the air storage tank for charging the compressed air storage tank while the compressor is coupled to the air storage tank.

9. The air compressor assembly as claimed in claim 1, further comprising a storage case mounted to at least one of the air compressor and the compressed air storage tank for storing an accessory, the storage case being removable from at least one of the air compressor and compressed air storage tank.

10. An air compressor assembly, comprising:
a compressed air storage tank for storing compressed air;
an air compressor for providing compressed air suitable for storage in the compressed air storage tank; and
a mounting assembly for mounting the air compressor to the compressed air storage tank so that the air compressor is removable from the compressed air storage tank;
wherein at least one of the air compressor and the compressed air storage tank is configured for being used independently of the other of the air compressor and the compressed air storage tank for providing compressed air.

11. The air compressor assembly as claimed in claim 10, wherein the compressed air storage tank comprises a vertically oriented cylindrical compressed air storage tank having an upper end and a lower end and the mounting assembly comprises a mounting collar disposed over the upper end for receiving the air compressor.

12. The air compressor assembly as claimed in claim 11, wherein the mounting collar includes a pressure gage and a pressure relief valve.

13. The air compressor assembly as claimed in claim 11, wherein the mounting assembly comprises a latch assembly for engaging the air compressor for securing the air compressor to the compressed air storage tank.

14. The air compressor assembly as claimed in claim 10, further comprising a hose assembly for coupling the air compressor to the compressed air storage tank for supplying compressed air to the air storage tank.

15. The air compressor assembly as claimed in claim 14, wherein the hose assembly is used to draw air from the compressed air storage tank when the air compressor is detached from compressed air storage tank.

16. The air compressor assembly as claimed in claim 10, wherein the air compressor supplies compressed air to the air storage tank for charging the compressed air storage tank while the compressor is coupled to the air storage tank.

17. The air compressor assembly as claimed in claim 10, further comprising a storage case mounted to at least one of the air compressor and the compressed air storage tank for storing an accessory, the storage case being removable from at least one of the air compressor and compressed air storage tank.

18. An air compressor assembly, comprising:
means for storing compressed air;
means for compressing air for storage in the compressed air storing means; and
means for mounting the compressing means to the compressed air storing means so that the compressing means is removable from the compressed air storing means;
wherein at least one of the compressing means and the compressed air storing means is configured for being used independently of the other of the compressing means and the compressed air storing means for providing compressed air.

19. The air compressor assembly as claimed in claim 18, further comprising means for coupling the compressing means to the compressed air storing means for supplying compressed air to the compressed air storing means.

20. The air compressor assembly as claimed in claim 10, further comprising means, mounted to at least one of the compressing means and the compressed air storing means for storing an accessory, the storing means being removable from at least one of the compressing means and the compressed air storing means.
